(19) United States
(12) Patent Application Publication
(10) Pub. No.: US 2005/0200349 A1
(43) Pub. Date: Sep. 15, 2005

(54) Method and apparatus of determining gas turbine shaft speed

(76) Inventor: Brant Duke, Lasalle (CA)

Correspondence Address: OGILVY RENAULT LLP (PWC), 1981 MCGILL COLLEGE AVENUE, SUITE 1600, MONTREAL, QC, H3A 2Y3, CA

(21) Appl. No.: 10/800,027

(22) Filed: Mar. 15, 2004

(51) Int. Cl. F03D 9/00; H02P 9/04; G01P 3/48

(52) U.S. Cl. 324/166

(57) ABSTRACT

A method and apparatus for determining a gas turbine shaft speed using a signal obtained from an alternator driven by the gas turbine shaft. Frequency information of the signal, indicative of alternator rotation, is used to determine gas turbine shaft speed.

### TECHNICAL FIELD

This invention relates to the field of gas turbine engines. More precisely, this invention concerns the determination of a gas turbine engine shaft speed.

### BACKGROUND

Sensors are crucial in operating rotating gas turbine engines. Among those sensors is the turbine shaft rotation speed sensor, sometimes called the “N2 sensor” which provides data regarding the rotation speed of the low spool shaft, typically, and which is a primary input variable necessary for the control logic of the gas turbine engine. In the prior art, such sensors are typically mechanical and located near the shaft to directly collect data on the rotation speed of the shaft. However, the prior art is costly, heavy and suffers from reliability concerns, as do all mechanical devices.

There is therefore a need for a sensing method and apparatus for providing a gas turbine shaft speed.

### SUMMARY

According to a first broad aspect of the invention, there is provided a method of determining a turbine shaft speed of a gas turbine engine, the engine having a turbine shaft drivingly connected to an alternator, the alternator adapted to generate electricity for a first purpose, said method comprising receiving a frequency signal from the alternator, and determining said gas turbine shaft speed using said signal.

According to another broad aspect of the invention, there is provided an apparatus for determining a speed of a turbine shaft of a gas turbine engine, said apparatus comprising input means for receiving a rotation signal from an alternator driven by the turbine shaft, the alternator adapted to generate electricity for a first purpose, and a processing unit for determining said gas turbine shaft speed using said signal.

According to another broad aspect of the invention, there is provided an apparatus of operating a gas turbine engine, the engine having a turbine shaft drivingly connected to a permanent magnet alternator, the method comprising the steps of operating the engine to rotate the turbine shaft and thereby rotate the alternator, extracting generated electricity from the alternator to thereby provide operational electrical power to at least a first piece of equipment, extracting from the generated electricity a frequency indicative of alternator rotation speed, determining a rotation speed of the turbine shaft using said frequency, and providing the determined rotation speed to an engine controller for use in controlling operation of the gas turbine engine.

### BRIEF DESCRIPTION OF THE DRAWINGS

Further features and advantages of the present invention will become apparent from the following detailed description, taken in combination with the appended drawings, in which:

FIG. 1 is a partial cross-sectional view of a gas turbine engine, exemplary of an embodiment of the invention;

FIG. 2 is a flowchart showing determination of a gas turbine shaft speed using a signal received from an alternator, preferably such as a Permanent Magnet Alternator (PMA);

FIG. 3 is a flowchart showing a preferred embodiment of a step from FIG. 2; and

FIG. 4 is a block diagram showing an apparatus for determining the rotation speed of the gas turbine shaft in accordance with a preferred embodiment of the invention.

It will be noted that throughout the appended drawings, like features are identified by like reference numerals.

### DETAILED DESCRIPTION

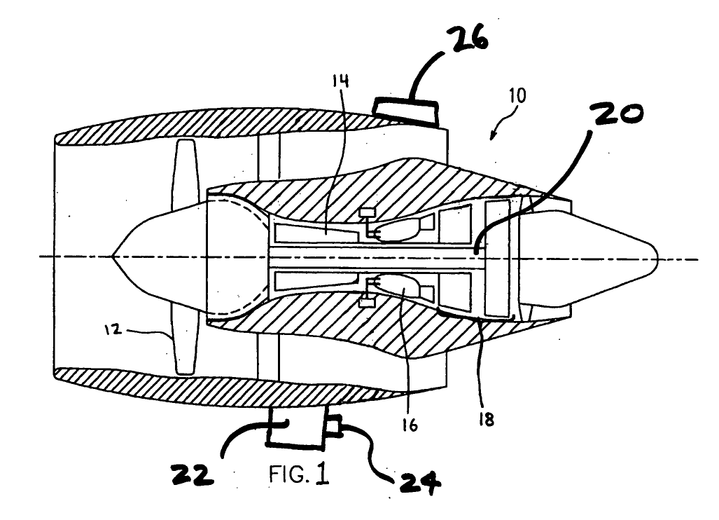

FIG. 1 illustrates a gas turbine engine 10 of a type preferably provided for use in subsonic flight, generally comprising in serial flow communication a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases. Engine 10 includes a turbine shaft 20 and an accessory gearbox (AGB) 22 drivingly connected to the shaft 20 (connection not shown). Appropriate gearing (not shown) is provided at a predetermined appropriate gear ratio. Mounted and drivingly connected to AGB 22 by suitable means (not shown) is an electrical alternator 24. Alternator 24 is thus driving connected to a main turbine shaft 20 via AGB 22. Electrical alternator 24 is adapted to provide output alternating current (AC) electricity, having a voltage and a current, at a frequency which is determined in part by its speed of rotation and in part by the internal construction of the alternator. The speed of rotation of alternator 24 is of course related to the speed of rotation of shaft 20, as will be described further below. Alternator 24 may be any suitable alternator configuration, and in the preferred embodiment alternator 24 is a permanent magnet alternator (PMA) 24 provided for the primary purpose of isolating the engine's Engine Electronic Control (EEC) 26 from possible power interruption power from the aircraft's power supply system (not shown). Interruptions of the aircraft-supplied power can cause the engine to shut down and thus the PMA isolates the EEC 26 from the power supply, to thereby provide a sort of uninterruptible power supply for the EEC.

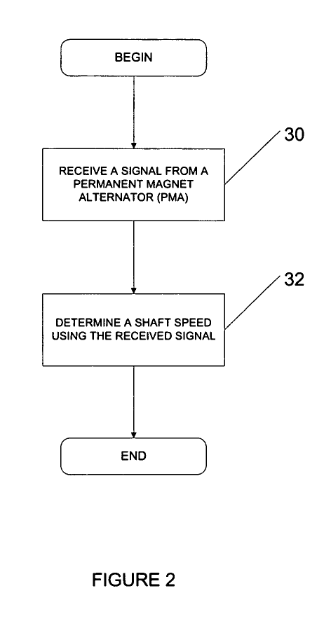

Now referring to FIG. 2, there is shown how the gas turbine shaft 20 speed is determined according to the present invention. According to step 30, a signal is received from a PMA 24. It will be appreciated that the received signal is generated by the PMA 24 in response to the rotation of the gas turbine shaft 20. According to step 32, a shaft speed is determined using the received signal. The input signal is preferably obtained from the AC electricity generated by the PMA 24.

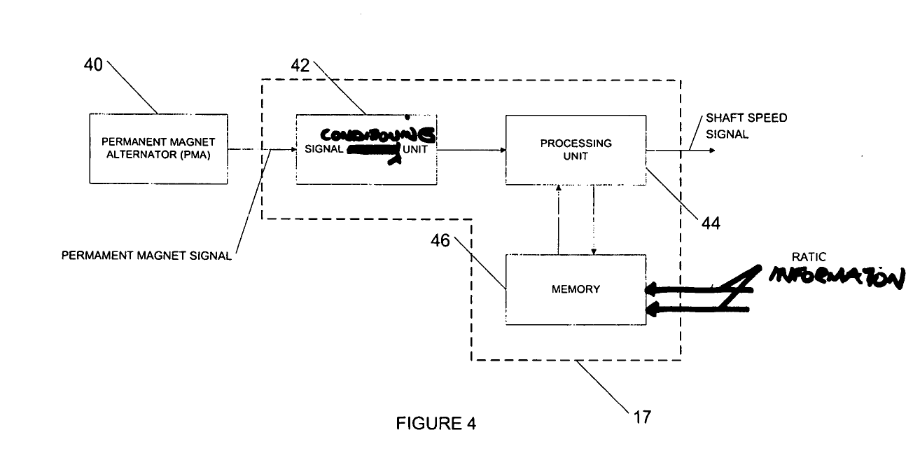

Prior to describing step 32 in more detail, a preferred embodiment of an apparatus 17 for determining the shaft 20 speed will be described in conjunction with FIG. 4.

In FIG. 4, the apparatus 17 for determining the shaft speed comprises a signal conditioning unit 42, a processing unit 44 and a memory 46, substantially provided in EEC 26. In a preferred embodiment of the invention, the signal conditioning unit 42 acts as the input means and receives, in a preferred embodiment of the invention, a permanent magnet signal from a PMA 40 (PMA 24 and PMA 40 being the same device, renumbered for convenience of explanation). The signal conditioning unit 42 performs conditioning of the alternator signal. As mentioned, the signal is preferably output AC electricity from the alternator. The signal conditioning circuitry preferably detects the negative to positive transition of voltage of the AC waveform produced by the PMA to provide raw frequency information. It preferably also converts the sinusoidal signal produced by the PMA to a square wave pulse train which can be used more easily by the processing unit. It also preferably limits the amplitude of the signal to levels suitable for the electronic components of processing unit 17.

As mentioned, in a preferred embodiment of the invention, the signal from the PMA is a voltage signal and the conditioning unit 42 extracts a frequency component N from the alternator signal. The alternator signal is an AC signal which has a frequency which is proportional to the rotation speed of the PMA 24 and also proportional to the speed to the gas turbine shaft 20. Frequency and PMA rotation are related by a ratio R1, determined by the internal construction (e.g. number of magnetic poles, etc.) of the alternator (i.e. it is the number of AC cycles produced by the alternator for each revolution of the device), while PMA 24 rotation and shaft 20 rotation are related by a gear ratio R2, determined by the gearing ratio (if any) between the driving and driven shafts. Other ratios, collectively referred to herein as Rn, may also be pertinent to relate shaft 20 rotation speed to output frequency.

The processing unit 44 receives the conditioned alternator signal and provides the shaft speed signal. The processing unit 44 also receives ratio information R1, R2, . . . Rn preferably from memory 46. In a preferred embodiment, the appropriate rotation ratio R is pre-determined and thus pre-stored in memory 46 at manufacturing. Memory 46 need not be “memory” per se, as is used in the electronics or computing sense, but rather may be performed by any suitable electronic, mechanical or other device.

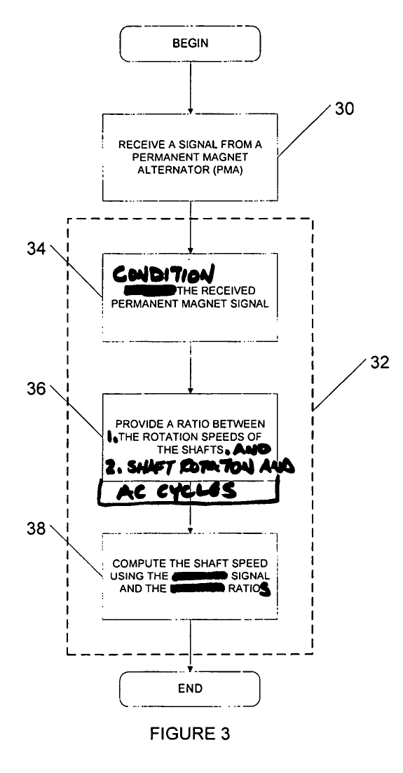

Now referring to FIG. 3, determination of the rotation speed of the shaft according to a preferred embodiment of the invention will now be discussed.

According to step 30, an alternator signal is received from the permanent magnet alternator 40 by the signal conditioning unit 42 of the purpose of determining 17 the speed of shaft 20.

According to step 32, the received alternator signal is conditioned by the signal conditioning unit 42. As explained above, the signal conditioning unit 42 performs a signal conditioning of the alternator signal and extracts a frequency component N of the alternator signal. Filtering and conditioning of the alternator signal may be also be provided to improve signal quality.

According to step 36, the cumulative ratio R between the rotation speed of the shaft and the frequency of the alternator signal is provided, where R=R1*R2*Rn. In a preferred embodiment the rotation ratio R is retrieved from the memory 46 where it is stored. According to step 38, the shaft speed Ω, expressed in Hz or rotation/s, is computed as Ω=R*N, where N, expressed in Hz, is the frequency of the alternator signal.

In an alternate embodiment, the shaft speed Ω may be computed using a lookup table (not shown) comprising a relation between a given signal frequency N and a corresponding shaft speed Ω. Such a lookup table may be implemented in memory 46. Optionally, an interpolation may be performed in order to limit the size of the lookup table. Ideally, interpolation would be performed by processing unit 44 using at least two values from the lookup table.

Unlike the prior art sensors, the present apparatus determines the shaft speed using existing equipment and data provided on the engine 10. Furthermore, in the preferred embodiment where the EEC PMA is used, failure mitigation is provided against the eventuality of a power supply interruption.

The embodiments of the invention described above are intended to be exemplary only, and modifications are available without departing from the scope of the invention disclosed. For example, although the use of a PMA is preferred, any alternator or other alternating current generating device in which the frequency is related to the rotation of a shaft of interest may be used. Still other modifications will be apparent to the skilled reader in light of the present disclosure. The scope of the invention is therefore intended to be limited solely by the scope of the appended claims.

1. A method of determining a turbine shaft speed of a gas turbine engine, the engine having a turbine shaft drivingly connected to an alternator, the alternator adapted to generate electricity for a first purpose, said method comprising:
receiving a rotation frequency signal from the alternator; and
determining said gas turbine shaft speed using said signal.

2. The method of claim 1, wherein said signal is derived from said generated electricity and the method further comprises conditioning said signal to extract a rotation frequency component therefrom.

3. The method of claim 1, wherein said determining said gas turbine shaft speed further comprises using a ratio representative of a relationship between rotation of said gas turbine shaft and said rotation frequency signal.

4. The method of claim 3, wherein said ratio comprises at least one of a gearing ratio between the gas turbine and alternator shafts and a ratio of alternator generated electrical signal cycles per revolution of the alternator.

5. The method of claim 2, wherein voltage is used to determine the rotation frequency component.

6. An apparatus for determining a speed of a turbine shaft of a gas turbine engine, said apparatus comprising:
input means for receiving a rotation signal from an alternator driven by the turbine shaft, the alternator adapted to generate electricity for a first purpose; and
a processing unit for determining said gas turbine shaft speed using said signal.

7. The apparatus of claim 6, wherein said signal comprises an alternator rotation frequency component and the apparatus further comprises a signal conditioning unit for extracting the frequency component from said signal.

8. The apparatus of claim 7, further comprising a ratio adjustment unit for storing a relationship ratio between a rotation speed of the turbine shaft said frequency component.

9. The apparatus of claim 8, wherein relationship ratio comprises at least one of a gear ratio between the turbine shaft and an alternator shaft and a frequency ratio between rotation of the alternator and number of AC cycles produced per alternator revolution.

10. The apparatus of claim 6, wherein said signal comprises an alternator voltage signal and the apparatus further comprises a signal conditioning unit for extracting the frequency component from said signal.

11. A method of operating a gas turbine engine, the engine having a turbine shaft drivingly connected to a permanent magnet alternator, the method comprising the steps of:
operating the engine to rotate the turbine shaft and thereby rotate the alternator;
extracting generated electricity from the alternator to thereby provide operational electrical power to at least a first piece of equipment;
extracting from the generated electricity a frequency indicative of alternator rotation speed;
determining a rotation speed of the turbine shaft using said frequency; and
providing the determined rotation speed to an engine controller for use in controlling operation of the gas turbine engine.

12. A method according to claim 12 wherein the first piece of equipment is the engine controller.

13. A method according to claim 12 wherein the frequency is a voltage frequency.
